(19) United States
(12) Patent Application Publication
(10) Pub. No.: US 2026/0250789 A1
(43) Pub. Date: Aug. 27, 2026

(54) AN INSTANTLY DISSOLVABLE JAGGERY CUBE AND A METHOD OF PREPARATION THEREOF

(71) Applicants: Yojna BHARDWAJ, New Delhi (IN); Shefali GUPTA, New Delhi (IN)

(72) Inventors: Yojna BHARDWAJ, New Delhi (IN); Shefali GUPTA, New Delhi (IN)

(21) Appl. No.: 18/993,847

(22) PCT Filed: Jul. 12, 2023
(86) PCT No.: PCT/IB2023/057146

§ 371 Date: Jan. 13, 2025

(30) Foreign Application Priority Data
Jul. 13, 2022 (IN) 202211040232

(51) Int. Cl. C13B 50/02; A23L 29/30; C13B 40/00; C13B 50/00

(52) U.S. Cl. CPC C13B 50/02; A23L 29/30; C13B 40/007; C13B 50/002

(57) ABSTRACT

The present invention relates generally to the field of Jaggery manufacturing. Particularly, the present disclosure provides an instantly dissolvable sugarcane, palm or coconut jaggery cube and a process for preparation thereof.

### FIELD OF THE INVENTION

The present invention relates generally to the field of food products. Particularly, the present invention provides an instantly dissolvable jaggery cube and a process for preparation thereof.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

These days, people are getting conscious of their food choices and have started choosing organic or natural substitutes of processed or ultra-processed food items. There is one area where people need better unprocessed food choice over given highly processed food choices.

Around the world, about 3.7 billion cups of tea and about 4 billion cups of coffee are consumed on a daily basis. A study in the May 2017 Public Health found that about two-thirds of coffee drinkers and one-third of tea drinkers put sugar (sugar cubes/powder) or sugary flavorings in their drinks. Apart from tea and coffee, many other hot/cold beverages are served across the globe after adding refined sugar. The long term use of white sugar (in the form of sugar cubes/granular/powder), which are being added to their cups of tea/coffee and other beverages, is affecting their physical wellbeing. Even the brown sugar cubes which are called better substitutes of white sugar cubes are not doing any better because they are also processed with various chemicals and have almost zero nutritional value.

Excessive use of such zero nutritional pure sugar is leading to various health issues across the world. Refined sugar intake is linked to conditions like obesity, type 2 diabetes, and heart disease. As per World Health Organisation (WHO), worldwide obesity has nearly tripled since 1975. In 2016, more than 1.9 billion adults (39% of adults), 18 years and older, were overweight. Of these over 650 million (13% of adults) were obese. Refined sugar intake is considered as one of the major causes of increase in obesity over the globe. Conscious of these problems, many people in the world want to shift from refined white/brown sugar to the unrefined/organic/healthier versions of sweeteners such as jaggery, honey etc.

Jaggery is considered as closest healthy substitute for refined white/brown sugar because it doesn't change the taste of the food product much in which it is added. As per present technologies, jaggery is produced in three forms, solid, granular and liquid. Though, jaggery is less expensive and has nutritional & medicinal values; its regular use in tea/coffee/other beverages and food preparations in its three existing forms, has certain challenges. In solid form of jaggery, the major challenge is its low solubility due to its extremely low permeability. The time-consuming process of dissolving solid jaggery in tea/coffee/other hot or cold beverages makes its use less attractive. Although, the granular/powder form of jaggery is dissolvable in tea/coffee/other beverages, yet its inherent moisture content leads to growth of microorganism in it and reduces its shelf life to few months. Moreover, due to its inherent moisture, it becomes sticky and less free flowing, which makes it inconvenient to use. Thus, there are convenience, hygiene and quality issues associated with the use of jaggery granules/jaggery powder, which makes it less attractive. Liquid form of jaggery has very limited usage in some food preparations, which is further marred by the same limitations as the granular form of jaggery.

On the industrial level, the available granular form of jaggery is not produced as a fine powder and due to which it has uneven moisture locked into different sizes of granules. It also has some un-dissolvable particles and stickiness. When compressed into the moulds, the uneven moisture gets busted and comes out on the surface of the cube and gets stuck to the moulds thereby making it impossible to form the cubes.

There is therefore, a need in the art to provide a new and improved form of jaggery and process for preparation thereof that is commercially acceptable, and overcome one or more problems associated with conventional forms and process of preparation. The present disclosure satisfies the existing needs.

### Objective of the Invention

Primary objective of the present invention is to provide a solution to overcome one or more problems associated with conventional forms of jaggery and process of preparation thereof.

Another objective of the present invention is to provide an instantly dissolvable jaggery cube.

Another objective of the present invention is to provide an instantly dissolvable jaggery cube that exhibits superior shelf-life.

Another objective of the present invention is to provide an instantly dissolvable jaggery cube that is commercially acceptable.

Another objective of the present invention is to provide a process of preparation of an instantly dissolvable jaggery cube.

Another objective of the present invention is to provide a process of preparation of an instantly dissolvable jaggery cube that is easy to follow.

Other objectives of the present invention will be apparent from the description of the invention herein below.

### SUMMARY OF THE INVENTION

The present invention relates generally to the field of Jaggery manufacturing. Particularly, the present disclosure provides an instantly dissolvable jaggery cube and a process for preparation thereof.

The inventors of the present invention surprisingly observed that when a jaggery cube is produced by taking sugarcane, palm or coconut jaggery granules/jaggery powder having a particular moisture level as a starting material, and grinding & sieving the material to arrive at a particular size and moisture of the granules, it affords the required level of moisture and the resultant cubes (instantly dissolvable jaggery cube) exhibit excellent dissolution property.

An aspect of the present disclosure provides a process of preparation of an instantly dissolvable jaggery cube, wherein instantly dissolvable jaggery cube is produced by using sugarcane, palm or coconut jaggery powder as a starting material.

In another aspect, the present invention provides a process of preparation of an instantly dissolvable jaggery cube, wherein the process comprising the steps of: a) taking a sugarcane, palm or coconut jaggery powder; b) grinding the jaggery powder; c) sieving the jaggery powder to obtain free flowing granules of particular size and moisture; d) forming jaggery cubes by compressing the granules in a mould at a particular compressive force; and (e) packaging the jaggery cube.

In an embodiment, the present invention relates to a process of preparing instantly dissolvable sugarcane, palm or coconut jaggery cubes, wherein the process comprises the steps of:
(a) grinding the sugarcane, palm, or coconut jaggery powder/granules having moisture level between 3% to 5% in a grinder to evenly spread the moisture;
(b) sieving the sugarcane, palm, or coconut jaggery powder/granules obtained in step (a) to obtain equal sized free flowing granules of 1 mm to 3 mm;
(c) pressing the free flowing granules with hydraulic press machine in moulds coated with a non-stick coating to obtain jaggery cubes;
(d) drying the jaggery cubes so formed at a temperature between 50° C. to 120° C. for a period of 5 minutes to 30 minutes to obtain dried jaggery cubes;
(e) cooling the dried jaggery cubes at a temperature between 15° C. to 40° C. for a period of 5 minutes to 30 minutes to obtain final jaggery cube; and
(f) packing the jaggery cubes in an aluminum based packaging paper with double sealing to ensure no moisture ingress into the final jaggery cube.

In an embodiment, the granules of sugarcane, palm or coconut jaggery obtained after sieving exhibit size in the range of 1 mm to 3 mm, preferably, in the range of 1.25 mm to 2.5 mm, and most preferably in the range of 1.5 mm to 2 mm. In an embodiment, the granules of jaggery have size of about 1.8 mm.

In an embodiment, the jaggery cubes are subjected to drying followed by cooling before packaging the jaggery cube. In an embodiment, the step of drying the jaggery cube comprises exposing the jaggery cubes to a temperature ranging from 50° C. to 120° C. for a time period ranging from 5 minutes to 30 minutes. In an embodiment, the step of drying the jaggery cube comprises exposing the jaggery cubes to a temperature ranging from 70° C. to 110° C. for a time period ranging from 10 minutes to 25 minutes. In an embodiment, the step of drying the jaggery cube comprises exposing the jaggery cubes to a temperature of about 90° C. for a time period of about 20 minutes. In an embodiment, the step of drying is effected by using hot air. In an embodiment, the step of cooling comprises exposing the dried cubes to a temperature ranging from 15° C. to 40° C. for a time period ranging from 5 minutes to 30 minutes. In an embodiment, the step of cooling comprises exposing the dried cubes to a temperature ranging from 20° C. to 30° C. for a time period ranging from 5 minutes to 15 minutes.

In an embodiment, step of sieving further comprises simultaneous removal of any un-dissolvable substances present in the jaggery powder.

Other aspects, advantages, and salient features of the invention will become apparent to those skilled in the art from the following detailed description, which, taken in conjunction with the exemplary embodiments of the invention.

### DETAILED DESCRIPTION OF THE INVENTION

The embodiments herein and the various features and advantageous details thereof are explained more comprehensively with reference to the non-limiting embodiments that are detailed in the following description. Descriptions of well-known components and processing techniques are omitted so as to not unnecessarily obscure the embodiments herein. The examples used herein are intended merely to facilitate an understanding of the ways in which the embodiments herein may be practiced and to further enable those of skill in the art to practice the embodiments herein. Accordingly, the examples should not be construed as limiting the scope of the embodiments herein.

Unless otherwise specified, all terms used in disclosing the invention, including technical and scientific terms, have the meaning as commonly understood by one of ordinary skill in the art to which this invention belongs. By means of further guidance, term definitions may be included to better appreciate the teaching of the present invention.

As used in the description herein, the meaning of “a,” “an,” and “the” includes plural reference unless the context clearly dictates otherwise. Also, as used in the description herein, the meaning of “in” includes “in” and “on” unless the context clearly dictates otherwise.

As used herein, the terms “comprise”, “comprises”, “comprising”, “include”, “includes”, and “including” are meant to be non-limiting, i.e., other steps and other ingredients which do not affect the end of result can be added. The above terms encompass the terms “consisting of” and “consisting essentially of”.

As used herein, the terms “composition”, “blend”, or “mixture” are all intended to be used interchangeably.

The terms “weight percent”, “vol-%”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like are intended to be synonymous with “weight percent”, “vol-%”, etc.

In some embodiments, the numbers expressing quantities of ingredients, properties such as concentration, reaction conditions, and so forth, used to describe and claim certain embodiments of the invention are to be understood as being modified in some instances by the term “about”. Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The present disclosure relates generally to the field of Jaggery manufacturing. Particularly, the present disclosure provides an instantly dissolvable jaggery cube and a process for preparation thereof.

An aspect of the present disclosure provides a process of preparation of an instantly dissolvable jaggery cube, wherein the instantly dissolvable jaggery cube is produced by using sugarcane/palm/coconut jaggery powder as a starting material.

Another aspect of the present disclosure provides a process of preparation of an instantly dissolvable jaggery cube, the process comprising the steps of: a) taking a sugarcane, palm or coconut jaggery powder; b) grinding the jaggery powder; c) sieving the jaggery powder to obtain free flowing granules of particular size and moisture; d) forming jaggery cubes by compressing the granules in a mould; and (e) packaging the jaggery cube.

In an embodiment, grinding and sieving helps balancing the moisture trapped in the jaggery granules and provide granules of desired size. In an embodiment, step of sieving further comprises simultaneous removal of any un-dissolvable substances present in the jaggery powder.

In an embodiment, moisture content of raw sugarcane, palm or coconut jaggery powder/granules is in a range of 3% to 5%. In another embodiment, moisture content of raw sugarcane, palm or coconut jaggery powder/granules is in a range of 3.5% to 4.5%.

In an embodiment, the granules of sugarcane, palm or coconut jaggery obtained after sieving exhibit size in the range of 1 mm to 3 mm, preferably, in the range of 1.25 mm to 2.5 mm, and most preferably in the range of 1.5 mm to 2.5 mm. In an embodiment, the granules of jaggery have size of about 1.8 mm. In an embodiment, the cubes are prepared by using any conventional method known to or appreciated by a person skilled in the art to serve the intended purpose.

In an embodiment, cubes are formed in a mould by judicious selection of compressive force, temperature and time-period to achieve the required density of the cubes.

In an embodiment, the pressing in a hydraulic press machine can be carried out at a compressive force in a range of 25 kg/cm² to 75 kg/cm² and at a density of about 0.85 to 1.10. In an embodiment, the pressing can be carried out at a compressive force in a range of 45 kg/cm² to 55 kg/cm² and at a density of about 0.95 to 1.0. In an embodiment, the pressing can be carried out at a compressive force of 50 kg/cm² and at a density of about 0.975.

In an embodiment, the mould is coated with a non-stick coating. In another embodiment, the non-sticking coating of the mould is hard chrome coating, CVD (chemical vapor deposition) coating and PVD (physical vapor deposition) coating.

In an embodiment, the jaggery cubes are subjected to drying followed by cooling before packaging the jaggery cube.

In an embodiment, jaggery cubes so obtained are dried by using any conventional method known to or appreciated by a person skilled in the art to serve the intended purpose. In an embodiment, the step of drying the jaggery cube comprises exposing the jaggery cubes in a conventional heater/convection heater/hot air heater to a temperature ranging from 50° C. to 120° C. for a time period ranging from 5 minutes to 30 minutes. In an embodiment, the step of drying the jaggery cube comprises exposing the jaggery cubes to a temperature ranging from 70° C. to 110° C. for a time period ranging from 10 minutes to 30 minutes. In an embodiment, the step of drying the jaggery cube comprises exposing the jaggery cubes to a temperature ranging from 80° C. to 90° C. for a period of 15 minutes to 25 minutes.

In an embodiment, the step of drying is effected by using hot air. In an embodiment, cubes are air dried at a temperature ranging from 50° C. to 120° C. In an embodiment, cubes are air dried at a temperature ranging from 70° C. to 110° C. In an embodiment, cubes are air dried for a time-period ranging from about 5 min to 30 min. In an embodiment, cubes are air dried for a time-period ranging from about 10 min to 25 min. In an embodiment, cubes are air dried for about 20 min.

In an embodiment, the step of cooling comprises exposing the dried cubes to a temperature ranging from 15° C. to 40° C. for a time period ranging from 5 minutes to 30 minutes. In an embodiment, the step of cooling comprises exposing the dried cubes to a temperature ranging from 20° C. to 30° C. for a time period ranging from 5 minutes to 20 minutes. In an embodiment, the step of cooling comprises exposing the dried cubes to a temperature ranging from 20° C. to 25° C. for a time period ranging from 5 minutes to 15 minutes. In an embodiment, the step of cooling comprises exposing the dried cubes to a temperature of about 25° C. In an embodiment, the step of cooling comprises exposing the dried cubes for about 10 min.

In an embodiment, after cooling, the instantly dissolvable jaggery cubes so obtained are immediately packed. In an embodiment, cubes are immediately packed into a single cube packing. In an embodiment, cubes are immediately packed into an aluminum foil packaging. In an embodiment, cubes are immediately packed into an aluminum foil packaging into a single cube packing.

In an embodiment, the instantly dissolvable jaggery cube exhibits moisture content of less than 2%. In an embodiment, the instantly dissolvable jaggery cube exhibits moisture content in the range of 0.5% to 2%. In an embodiment, the instantly dissolvable jaggery cube exhibits moisture content in the range of 0.5% to 1.5%. In an embodiment, the instantly dissolvable jaggery cube exhibits moisture content below 1%.

In another embodiment, the instantly dissolvable jaggery cube dissolved in a given beverage in a time period ranging from 2 seconds to 60 seconds. In an embodiment, the instantly dissolvable jaggery cubes dissolved in a given beverage in a time period ranging from 5 seconds to 30 seconds.

In another embodiment, the dissolution time of the instantly dissolvable jaggery cube is less than 20 seconds in hot water at a temperature of 60° C. to 70° C. with a stirring at 50 RPM.

In yet another embodiment, the dissolution time of the instantly dissolvable jaggery cube is less than 40 seconds in cold water at a temperature of 8° C. to 12° C. with a stirring at 50 RPM.

In another embodiment, the jaggery cubes can be spiced or flavored jaggery cubes. In an embodiment, the spices or flavours is selected from clove, ginger, pepper, cinnamon, cardamom, basil, nutmeg, turmeric, cocoa, coffee, chocolate, vanilla, strawberry, almond, Giloy, Ajwain, Fennel, Linseed, Fenugreek, Moringa, Cashew nut, and the like.

In an embodiment, the entire process steps are carried out in relative humidity (RH) controlled environment where RH is maintained below 35%.

In an embodiment, the present invention relates to a process of preparing instantly dissolvable sugarcane, palm or coconut jaggery cubes, wherein the process comprises the steps of:
(a) grinding the sugarcane, palm, or coconut jaggery powder/granules having moisture level between 3% to 5% in a grinder to evenly spread the moisture;
(b) sieving the sugarcane, palm, or coconut jaggery powder/granules obtained in step (a) to obtain equal sized free flowing granules of 1 mm to 3 mm;
(c) pressing the free flowing granules with hydraulic press machine in moulds coated with a non-stick coating to obtain jaggery cubes;
(d) drying the jaggery cubes so formed at a temperature between 50° C. to 120° C. for a period of 5 minutes to 30 minutes to obtain dried jaggery cubes;
(e) cooling the dried jaggery cubes at a temperature between 15° C. to 40° C. for a period of 5 minutes to 30 minutes to obtain final jaggery cube; and
(f) packing the jaggery cubes in an aluminum based packaging paper with double sealing to ensure no moisture ingress into the final jaggery cube.

In another embodiment, the present invention relates to a process of preparing instantly dissolvable sugarcane, palm or coconut jaggery cubes, wherein the process comprises the steps of:
(a) grinding the sugarcane, palm, or coconut jaggery powder/granules having moisture level between 3% to 5% in a grinder to evenly spread the moisture;
(b) sieving the sugarcane, palm, or coconut jaggery powder/granules obtained in step (a) to obtain equal sized free flowing granules of 1.5 mm to 2.5 mm;
(c) pressing the free flowing granules with hydraulic press machine in moulds coated with a non-stick coating to obtain jaggery cubes;
(d) drying the jaggery cubes so formed at a temperature between 80° C. to 90° C. for a period of about 20 minutes to obtain dried jaggery cubes;
(e) cooling the dried jaggery cubes at a temperature between 20° C. to 25° C. for a period of about 10 minutes to obtain final jaggery cube; and
(f) packing the jaggery cubes in an aluminum based packaging paper with double sealing to ensure no moisture ingress into the final jaggery cube.

In an embodiment, the process steps (a) to (f) are carried out in normal environment or in relative humidity (RH) controlled environment where RH is maintained below 35%.

In an embodiment, the process steps (a) to (f) are carried out in relative humidity (RH) controlled environment where RH is maintained below 35%.

In an embodiment, the cooling is carried out in relative humidity (RH) controlled environment where RH is maintained below 35%. In an embodiment, the packing is done in relative humidity (RH) controlled environment where RH is maintained below 35%.

In an embodiment, the cubes exhibit a shelf-life of more than 6 months. In an embodiment, the cubes exhibit a shelf-life of more than 12 months.

In an embodiment, the cubes exhibits less density and are permeable in nature as compared with the solid jaggery, and accordingly, are instantly dissolvable in hot/cold beverages and other food preparations thereby overcoming the problem of low solubility of solid jaggery. In an embodiment, in cold beverages, where refined white sugar cube fails to dissolve fully despite rigorous stirring, these jaggery cubes get quickly dissolved. This makes the instantly dissolvable jaggery cubes a perfect, healthy and even better substitute of refined white/brown sugar cubes.

In an embodiment, these cubes further overcome the problem of inherent moisture content of jaggery granules/jaggery powder as the moisture content of the raw jaggery granules is balanced in the first phase of production through grinding and sieving to get the evenly spread moisture across desired size of the granules. This also solves the problem of stickiness. Moreover, the problem of stickiness is further solved by using a specific quality stainless steel material with non-sticky coating for making dies of the machine. Thereafter, in the process of drying the cubes, the moisture is taken out of the cubes to the level of acceptable industry norms to avoid microbial activity. In an embodiment, cubes are immediately packed into the aluminum foil packaging into single cube packing to further ensure almost nil microbial activity during the enhanced shelf life.

Moreover, it is very easy for the consumers to shift from one type of sweetener cubes to the healthier version of sweetener cube as there is no change in the convenience of use and its storage, and thus there is no need to change the habit pattern of the consumers. This will make the instantly dissolvable jaggery cubes a commercially acceptable substitute.

### EXAMPLES

The present invention is further explained in the form of following examples. However, it is to be understood that the following examples are merely illustrative and are not to be taken as limitations upon the scope of the invention.

### Example 1: Instantly Dissolvable Sugarcane Jaggery Cubes

| | Sugarcane Jaggery |
|---|---|
| | Granules/Powder |
| Raw Material | sourced from open market |
| Quantity of Raw Material | 100 grams |
| Moisture Content of Raw Material | 4% |
| Color of the Raw Material | Light Brown |
| Relative Humidity of Environment | Below 35% |

### Manufacturing Steps

Step I: Tested moisture level of the Raw Material in Wensar Moisture Analyzer PGB-1 MB model and got the reading as 4% moisture in the material.
Step II: Carried out grinding of the 100 μm Raw Material in a grinder at 15000 RPM for 5 seconds and obtained evenly spread moisture in the jaggery granules.
Step III: Sieved the Raw Material obtained in Step II by using a Sieve No. 10 (ASTM E11) having openings of 2 mm to obtain the jaggery granules of maximum size of 2 mm. During this step all the un-dissolvable substances in the raw material were removed. The net quantity of the raw material left is 80 μm.
Step IV: Poured the Raw Material obtained in the Step III into the 18 mm×18 mm moulds made of stainless steel coated with hard chrome to ensure 100% release property. Each mould filled with 5 μm raw material.
Step V: Compressed the mould with 50 KG/cm² compressive force to form the sugarcane jaggery cubes with dimensions of 18 mm×18 mm×16 mm (L×B×H) and a density of 0.965.
Step VI: Dried the 16 Nos cubes obtained in Step V in a conventional dryer heater with hot air circulation at a temperature of 85° C. for 20 minutes. Each cube after drying showed the weight loss of 0.16 μm (3.20%). The moisture level was checked in Wensar Moisture Analyzer PGB-1 MB model and got the reading as 0.80% moisture in the cube.
Step VII: Cooled the dried cubes obtained in Step VI at a temperature of 25° C. for 10 minutes. After cooling the moisture level was checked in Wensar Moisture Analyzer PGB-1 MB model and got the reading as 0.85% moisture in the cube. The color of the final cube was light brown.
Step VIII: Packed the cooled cubes obtained in Step VII in aluminum foil packaging as an individual candy packing for each cube.
Step IX: Dissolution test conducted by dropping the cube obtained in Step VIII in a hot water having temperature of 70° C. and stirring at 50 RPM. The cube was fully dissolved in the water in 15 seconds.
Step X: Dissolution test conducted by dropping the cube obtained in Step VIII in a cold water having temperature of 10° C. and stirring at 50 RPM. The cube was fully dissolved in the water in 35 seconds.

### Example 2: Instantly Dissolvable Palm Jaggery Cubes

| | Palm Jaggery |
|---|---|
| | Granules/Powder |
| Raw Material | sourced from open market |
| Quantity of Raw Material | 100 grams |
| Moisture Content of Raw Material | 3.75% |
| Color of the Raw Material | Brown |
| Relative Humidity of Environment | Below 35% |

### Manufacturing Steps:

Step I: Tested moisture level of the Raw Material in Wensar Moisture Analyzer PGB-1 MB model and got the reading as 3.75% moisture in the material.
Step II: Carried out grinding of the 100 μm Raw Material in a grinder at 15000 RPM for 5 seconds and obtained evenly spread moisture in the jaggery granules.
Step III: Sieved the Raw Material obtained in Step II by using a Sieve No. 10 (ASTM E11) having openings of 2 mm to obtain the jaggery granules of maximum size of 2 mm. During this step all the un-dissolvable substances in the raw material were removed. The net quantity of the raw material left is 80 μm.
Step IV: Poured the Raw Material obtained in the Step III into the 18 mm×18 mm moulds made of stainless steel coated with CVD Coating to ensure 100% release property. Each mould filled with 5 μm raw material.
Step V: Compressed the mould with 50 KG/cm² compressive force to form the palm jaggery cubes with dimensions of 18 mm×18 mm×16 mm (L×B×H) and a density of 0.965.
Step VI: Dried the 16 Nos. cubes so obtained in Step V in a conventional dryer heater with hot air circulation at a temperature of 85° C. for 20 minutes. Each cube after drying showed the weight loss of 0.15 μm (3%). The moisture level was checked in Wensar Moisture Analyzer PGB-1 MB model and got the reading as 0.75% moisture in the cube.
Step VII: Cooled the dried cubes obtained in Step VI at a temperature of 25° C. for 10 minutes. After cooling the moisture level was checked in Wensar Moisture Analyzer PGB-1 MB model and got the reading as 0.79% moisture in the cube. The color of the final cube was brown.
Step VIII: Packed the cooled cubes obtained in Step VII in aluminum foil packaging as an individual candy packing for each cube.
Step IX: Dissolution test conducted by dropping the cube obtained in Step VIII in a hot water having temperature of 70° C. and stirring at 50 RPM. The cube was fully dissolved in the water in 14 seconds.
Step X: Dissolution test conducted by dropping the cube obtained in Step VIII in a cold water having temperature of 10° C. and stirring at 50 RPM. The cube was fully dissolved in the water in 35 seconds.

### Example 3: Instantly Dissolvable Coconut Jaggery Cubes

| | Coconut Jaggery |
|---|---|
| | Granules/Powder |
| Raw Material | sourced from open market |
| Quantity of Raw Material | 100 grams |
| Moisture Content of Raw Material | 3.80% |
| Color of the Raw Material | Brown |
| Relative Humidity of Environment | Below 35% |

### Manufacturing Steps:

Step I: Tested moisture level of the Raw Material in Wensar Moisture Analyzer PGB-1 MB model and got the reading as 3.80% moisture in the material.
Step II: Carried out grinding of the 100 μm Raw Material in a grinder at 15000 RPM for 5 seconds and obtained evenly spread moisture in the jaggery granules.
Step III: Sieved the Raw Material obtained in Step II by using a Sieve No. 10 (ASTM E11) having openings of 2 mm to obtain the jaggery granules of maximum size of 2 mm. During this step all the un-dissolvable substances in the raw material have also been removed. The net quantity of the raw material left is 80 μm.
Step IV: Poured the Raw Material obtained in the Step III into the 18 mm×18 mm moulds made of stainless steel coated with PVD Coating to ensure 100% release property. Each mould filled with 5 μm raw material.
Step V: Compressed the mould with 50 KG/cm² compressive force to form the coconut jaggery cubes with dimensions of 18 mm×18 mm×16 mm (LxBxH) and a density of 0.965.
Step VI: Dried the 16 Nos. cubes so obtained in Step V in a conventional dryer heater with hot air circulation at a temperature of 85° C. for 20 minutes. Each cube after drying was showed the weight loss of 0.15 μm (3%). The moisture level was checked in Wensar Moisture Analyzer PGB-1 MB model and got the reading as 0.80% moisture in the cube.
Step VII: Cooled the dried cubes obtained in Step VI at a temperature of 25° C. for 10 minutes. After cooling the moisture level was checked in Wensar Moisture Analyzer PGB-1 MB model and got the reading as 0.85% moisture in the cube. The color of the final cube was brown.
Step VIII: Packed the cooled cubes obtained in Step VII in aluminum foil packaging as an individual candy packing for each cube.
Step IX: Dissolution test conducted by dropping the cube obtained in Step VIII in a hot water having temperature of 70° C. and stirring at 50 RPM. The cube was fully dissolved in the water in 15 seconds.
Step X: Dissolution test conducted by dropping the cube obtained in Step VIII in a cold water having temperature of 10° C. and stirring at 50 RPM. The cube was fully dissolved in the water in 35 seconds.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

### Advantages of the Present Invention

The present disclosure provides an instantly dissolvable jaggery cube that may overcome one of more problems associated with conventional forms of jaggery and process of preparation thereof.

The present disclosure provides an instantly dissolvable jaggery cube.

The present disclosure provides an instantly dissolvable jaggery cube that exhibits evenly spread moisture across the cube while forming the cube in moulds.

The present disclosure provides an instantly dissolvable jaggery cube that exhibits the moisture level acceptable as per industry norms in dried cubes.

The present disclosure provides an instantly dissolvable jaggery cube that exhibits almost nil microbial activity after packing during its shelf life.

The present disclosure provides an instantly dissolvable jaggery cube that exhibits superior shelf-life.

The present disclosure provides an instantly dissolvable jaggery cube that is commercially acceptable.

The present disclosure provides a process of preparation of an instantly dissolvable jaggery cube.

The present disclosure provides a process of preparation of an instantly dissolvable jaggery cube that is easy to follow.

We claim:

1. A process of preparing instantly dissolvable sugarcane, palm or coconut jaggery cubes, wherein the process comprises the steps of:
(a) grinding the sugarcane, palm, or coconut jaggery powder/granules having moisture level between 3% to 5% in a grinder to evenly spread the moisture;
(b) sieving the sugarcane, palm, or coconut jaggery powder/granules obtained in step (a) to obtain equal sized free flowing granules of 1.5 mm to 2.5 mm;
(c) pressing the free flowing granules with hydraulic press machine in moulds coated with a non-stick coating to obtain jaggery cubes;
(d) drying the jaggery cubes so formed at a temperature between 80° C. to 90° C. for a period of 15 minutes to 30 minutes to obtain dried jaggery cubes;
(e) cooling the dried jaggery cubes at a temperature between 20° C. to 25° C. for a period of 5 minutes to 20 minutes to obtain final jaggery cube; and
(f) packing the jaggery cubes in an aluminium based packaging paper with double sealing to ensure no moisture ingress into the final jaggery cube.

2. The process as claimed in claim 1, wherein the sieving step further comprises removing of un-dissolvable substances present in the sugarcane, palm, or coconut jaggery powder.

3. The process as claimed in claim 1, wherein the process further comprises adding spices or flavours to the jaggery cubes.

4. The process as claimed in claim 1, wherein the pressing step (c) is carried out at a compressive force in a range of 25 kg/cm² to 75 kg/cm² and at a density of about 0.85 to 1.10.

5. The process as claimed in claim 1, wherein the process steps are carried out in relative humidity (RH) controlled environment where RH is maintained below 35%.

6. The process as claimed in claim 1, wherein moisture content of the final jaggery cube is less than 2%.

7. The process as claimed in claim 1, wherein dissolution time of the jaggery cube is less than 20 seconds in hot water at a temperature of 60° C. to 70° C. with a stirring at 50 RPM.

8. The process as claimed in claim 1, wherein dissolution time of the jaggery cube is less than 40 seconds in cold water at a temperature of 8° C. to 12° C. with a stirring at 50 RPM.

9. The process as claimed in claim 3, wherein the spices or flavours is selected from clove, ginger, pepper, cinnamon, cardamom, basil, nutmeg, turmeric, cocoa, coffee, chocolate, vanilla, strawberry, almond, Giloy, Ajwain, Fennel, Linseed, Fenugreek, Moringa, and Cashew nut.

10. The process as claimed in claim 1, wherein the non-stick coating is hard chrome coating, CVD (chemical vapor deposition) coating and PVD (physical vapor deposition) coating.
